(19) United States
(12) Patent Application Publication
(10) Pub. No.: US 2021/0103853 A1
(43) Pub. Date: Apr. 8, 2021

(54) System, Method, and Computer Program Product for Determining the Importance of a Feature of a Machine Learning Model

(71) Applicant: Visa International Service Association, San Francisco, CA (US)

(72) Inventors: Hangqi Zhao, Austin, TX (US); Yiwei Cai, Austin, TX (US); Dan Wang, Austin, TX (US); Sheng Wang, Austin, TX (US)

(21) Appl. No.: 16/593,175

(22) Filed: Oct. 4, 2019

(51) Int. Cl. G06N 20/00

(52) U.S. Cl. CPC G06N 20/00

(57) ABSTRACT

Provided is a method that includes determining a plurality of features of a dataset associated with a machine learning model that has been trained, determining a value of at least one feature in each data record of a plurality of data records in the dataset, calculating an average value of the at least one feature in each data record, replacing an original value of the at least one feature in each data record with the average value of the values of the at least one feature in each data record, and determining a metric of model performance of the machine learning model based on the dataset that includes the original value of the at least one feature in each data record replaced with the average value of the values of the at least one feature in each data record. A system and computer program product are also provided.

### BACKGROUND

### 1. Field

This disclosure relates generally to machine learning models and, in some non-limiting aspects or embodiments, to systems, methods, and computer program products for determining the importance of a feature of a machine learning model.

### 2. Technical Considerations

Machine learning may be a field of computer science that uses statistical techniques to provide a computer system with the ability to learn (e.g., to progressively improve performance of) a task with data without the computer system being explicitly programmed to perform the task. In some instances, a machine learning model may be developed for a set of data so that the machine learning model may perform a task (e.g., a task associated with a prediction) with regard to the set of data.

A feature of a machine learning model may include an attribute (e.g., a characteristic, a property, and/or the like) shared by all independent units of a dataset on which analysis is to be performed by the machine learning model. The feature may have a value, such as a numerical value, associated with the attribute. In addition, feature importance may refer to a measurement of a contribution that a feature makes to an output of the analysis, such as a prediction or a classification, of the machine learning model. Feature importance may be used to understand behavior of the machine learning model, to detect errors in a dataset to avoid potential failures during implementation of the machine learning model, and to validate a governance process associated with the machine learning model.

In some instances, the importance of a feature of a machine learning model may be obtained by changing a value of the feature (e.g., by removing a value of the feature to provide a value of 0 for the feature in each data record of the dataset or by replacing the values of the feature in each data record of the dataset with a single value, such as a value of 1) in each data record of a dataset to provide a modified dataset, and the machine learning model may be re-trained using the modified dataset. A performance of the re-trained machine learning model for the feature may be determined based on evaluation data. The process may be repeated for each feature of a plurality of features that are included in each data record of the dataset. The feature importance of each feature of the plurality of features may be determined based on the performance of the machine learning model for each feature. A first feature may be determined to rank higher in feature importance than a second feature if the re-trained machine learning model had worse performance when the first feature was changed as compared to the performance of the re-trained machine learning model when the second feature was changed.

However, re-training a machine learning model when each feature of a plurality of features in a dataset is changed may take an enormous amount of time. This may be especially true with deep learning models that are known to, in some instances, extend training time and rely on a large number of input features. In addition, the machine learning model may need to be re-trained more than once when each feature of the plurality of features in the dataset is changed to ensure that results are properly obtained.

### SUMMARY

Accordingly, disclosed are systems, methods, and computer program products for identifying the feature importance of a feature of a machine learning model.

According to some non-limiting aspects or embodiments, provided is a computer implemented method for determining the feature importance of a feature of a machine learning model, the method comprising: determining, with at least one processor, a plurality of features of a dataset associated with a machine learning model that has been trained, wherein the dataset was used to train the machine learning model; determining, with at least one processor, a value of at least one feature of the plurality of features in each data record of a plurality of data records in the dataset; calculating, with at least one processor, an average value of the values of the at least one feature in each data record of the plurality of data records in the dataset; replacing, with at least one processor, an original value of the at least one feature in each data record of the plurality of data records in the dataset with the average value of the values of the at least one feature in each data record of the plurality of data records in the dataset; and determining, with at least one processor, a metric of model performance of the machine learning model based on the dataset that includes the original value of the at least one feature in each data record of the plurality of data records in the dataset replaced with the average value of the values of the at least one feature in each data record of the plurality of data records in the dataset.

According to some non-limiting aspects or embodiments, provided is a system for determining the feature importance of a feature of a machine learning model, comprising: at least one processor programmed or configured to: determine a plurality of features in each data record of a plurality of data records in a dataset associated with a machine learning model that has been trained; determine a value of a subset of features of the plurality of features in each data record; calculate an average value of the values of the subset of features in each data record; replace an original value of each feature in the subset of features in each data record with the average value of the values of the subset of features in each data record; and determine a metric of model performance of the machine learning model based on the dataset that includes the original value of each feature in the subset of features in each data record replaced with the average value of the values of the subset of features in each data record.

According to some non-limiting aspects or embodiments, provided is a computer program product for determining the feature importance of a feature of a machine learning model, the computer program product comprising at least one non-transitory computer-readable medium including one or more instructions that, when executed by at least one processor, cause the at least one processor to: determine a plurality of features of a dataset associated with a machine learning model that has been trained, wherein the dataset was used to train the machine learning model; determine a value of at least one feature of the plurality of features in each data record of a plurality of data records in the dataset; calculate an average value of the values of the at least one feature in each data record of the plurality of data records in the dataset; replace an original value of the at least one feature in each data record of the plurality of data records in the dataset with the average value of the values of the at least one feature in each data record of the plurality of data records in the dataset; and determine a metric of model performance of the machine learning model based on the dataset that includes the original value of the at least one feature in each data record of the plurality of data records in the dataset replaced with the average value of the values of the at least one feature in each data record of the plurality of data records in the dataset.

Further non-limiting aspects or embodiments are set forth in the following numbered clauses:

Clause 1: A computer implemented method for determining the feature importance of a feature of a machine learning model, the method comprising: determining, with at least one processor, a plurality of features of a dataset associated with a machine learning model that has been trained, wherein the dataset was used to train the machine learning model; determining, with at least one processor, a value of at least one feature of the plurality of features in each data record of a plurality of data records in the dataset; calculating, with at least one processor, an average value of the values of the at least one feature in each data record of the plurality of data records in the dataset; replacing, with at least one processor, an original value of the at least one feature in each data record of the plurality of data records in the dataset with the average value of the values of the at least one feature in each data record of the plurality of data records in the dataset; and determining, with at least one processor, a metric of model performance of the machine learning model based on the dataset that includes the original value of the at least one feature in each data record of the plurality of data records in the dataset replaced with the average value of the values of the at least one feature in each data record of the plurality of data records in the dataset.

Clause 2: The computer implemented method of clause 1, further comprising: determining whether the metric of model performance of the machine learning model based on the average value of the values of the at least one feature satisfies a threshold value of the metric of model performance of the machine learning model.

Clause 3: The computer implemented method of clauses 1 or 2, wherein the threshold value of the metric of model performance of the machine learning model is an evaluation result of the machine learning model using the dataset that includes the original value of the at least one feature in each data record of the plurality of data records in the dataset.

Clause 4: The computer implemented method of any of clauses 1-3, wherein the at least one feature is a group of features, the method further comprising: randomly selecting the group of features from the plurality of features.

Clause 5: The computer implemented method of any of clauses 1-4, wherein determining the value of the at least one feature of the plurality of features in each data record of the plurality of data records in the dataset comprises: determining the value of each feature of the group of features of the plurality of features in each data record of the plurality of data records in the dataset; and wherein replacing the original value of the at least one feature in each data record of the plurality of data records in the dataset with the average value of the values of the at least one feature in each data record of the plurality of data records in the dataset comprises: replacing the original value of each feature of the group of features in each data record of the plurality of data records in the dataset with the average value of the values of each feature of the group of features in each data record of the plurality of data records in the dataset.

Clause 6: The computer implemented method of any of clauses 1-5, wherein the at least one feature is a first group of features, wherein determining the metric of model performance of the machine learning model based on the dataset that includes the original value of the at least one feature in each data record of the plurality of data records in the dataset replaced with the average value of the values of the at least one feature in each data record of the plurality of data records in the dataset comprises: determining a first metric of model performance of the machine learning model based on the dataset that includes the original value of each feature of the first group of features in each data record of the plurality of data records in the dataset replaced with the average value of the values of each feature of the first group of features in each data record of the plurality of data records in the dataset; the method further comprising: determining a second metric of model performance of the machine learning model based on the dataset that includes an original value of each feature of a second group of features in each data record of the plurality of data records in the dataset replaced with an average value of values of each feature of a second group of features in each data record of the plurality of data records in the dataset; wherein the first group of features includes a group of features that is different than a group of features included in the second group of features.

Clause 7: The computer implemented method of any of clauses 1-6, further comprising: determining whether the first metric of model performance of the machine learning model based on the average value of the values of each feature of the first group of features satisfies a threshold value of a metric of model performance of the machine learning model; and determining whether the second metric of model performance of the machine learning model based on the average value of the values of each feature of the second group of features satisfies the threshold value of a metric of model performance of the machine learning model.

Clause 8: The computer implemented method of any of clauses 1-7, wherein the metric of model performance of the machine learning model based on the average value of the values of the at least one feature is a first metric of model performance based on the average value of the values of a first feature, the method further comprising: comparing the first metric of model performance to a second metric of model performance of the machine learning model based on an average value of values of a second feature; determining whether the first metric of model performance indicates worse model performance than the second metric of model performance; and selecting the first metric of model performance or the second metric of model performance based on determining whether the first metric of model performance indicates worse model performance than the second metric of model performance.

Clause 9: The computer implemented method of any of clauses 1-8, wherein determining the metric of model performance of the machine learning model based on the dataset that includes the original value of the at least one feature in each data record of the plurality of data records in the dataset replaced with the average value of the values of the at least one feature in each data record of the plurality of data records in the dataset comprises: determining the metric of model performance of the machine learning model based on the dataset independent of re-training the machine learning model based on the dataset that includes the original value of the at least one feature in each data record of the plurality of data records in the dataset replaced with the average value of the values of the at least one feature in each data record of the plurality of data records in the dataset.

Clause 10: A system for determining the feature importance of a feature of a machine learning model, comprising: at least one processor programmed or configured to: determine a plurality of features in each data record of a plurality of data records in a dataset associated with a machine learning model that has been trained; determine a value of a subset of features of the plurality of features in each data record; calculate an average value of the values of the subset of features in each data record; replace an original value of each feature in the subset of features in each data record with the average value of the values of the subset of features in each data record; and determine a metric of model performance of the machine learning model based on the dataset that includes the original value of each feature in the subset of features in each data record replaced with the average value of the values of the subset of features in each data record.

Clause 11: The system of clause 10, wherein the at least one processor is further programmed or configured to: determine whether the metric of model performance of the machine learning model based on the average value of the values of the subset of features satisfies a threshold value of a metric of model performance of the machine learning model; and wherein the threshold value of the metric of model performance of the machine learning model is an evaluation result of the machine learning model using the dataset that includes the original value of the subset of features in each data record of the plurality of data records in the dataset.

Clause 12: The system of clauses 10 or 11, wherein the at least one processor is further programmed or configured to: randomly select the subset of features from the plurality of features.

Clause 13: The system of any of clauses 10-12, wherein the at least one feature is a first group of features, and wherein when determining the metric of model performance of the machine learning model based on the dataset that includes the original value of the at least one feature in each data record of the plurality of data records in the dataset replaced with the average value of the values of the at least one feature in each data record of the plurality of data records in the dataset, the at least one processor is programmed or configured to: determine a first metric of model performance of the machine learning model based on the dataset that includes the original value of each feature of the first group of features in each data record of the plurality of data records in the dataset replaced with the average value of the values of each feature of the first group of features in each data record of the plurality of data records in the dataset; and wherein the at least one processor is further programmed or configured to: determine a second metric of model performance of the machine learning model based on the dataset that includes an original value of each feature of a second group of features in each data record of the plurality of data records in the dataset replaced with an average value of values of each feature of a second group of features in each data record of the plurality of data records in the dataset; and wherein the first group of features includes a group of features that is different than a group of features included in the second group of features.

Clause 14: The system of any of clauses 10-13, wherein the at least one processor is further programmed or configured to: determine whether the first metric of model performance of the machine learning model based on the average value of the values of each feature of the first group of features satisfies a threshold value of a metric of model performance of the machine learning model; and determine whether the second metric of model performance of the machine learning model based on the average value of the values of each feature of the second group of features satisfies the threshold value of a metric of model performance of the machine learning model.

Clause 15: The system of any of clauses 10-14, wherein when determining the metric of model performance of the machine learning model based on the dataset that includes the original value of each feature in the subset of features in each data record replaced with the average value of the values of the subset of features in each data record, the at least one processor is programmed or configured to: determine the metric of model performance of the machine learning model based on the dataset independent of re-training the machine learning model based on the dataset that includes the original value of each feature in the subset of features in each data record replaced with the average value of the values of the subset of features in each data record.

Clause 16: A computer program product for determining the feature importance of a feature of a machine learning model, the computer program product comprising at least one non-transitory computer-readable medium including one or more instructions that, when executed by at least one processor, cause the at least one processor to: determine a plurality of features of a dataset associated with a machine learning model that has been trained, wherein the dataset was used to train the machine learning model; determine a value of at least one feature of the plurality of features in each data record of a plurality of data records in the dataset; calculate an average value of the values of the at least one feature in each data record of the plurality of data records in the dataset; replace an original value of the at least one feature in each data record of the plurality of data records in the dataset with the average value of the values of the at least one feature in each data record of the plurality of data records in the dataset; and determine a metric of model performance of the machine learning model based on the dataset that includes the original value of the at least one feature in each data record of the plurality of data records in the dataset replaced with the average value of the values of the at least one feature in each data record of the plurality of data records in the dataset.

Clause 17: The computer program product of clause 16, wherein the at least one feature is a group of features and wherein the one or more instructions further cause the at least one processor to: randomly select the group of features from the plurality of features.

Clause 18: The computer program product of clauses 16 or 17, wherein the one or more instructions that cause the at least one processor to determine the value of the at least one feature of the plurality of features in each data record of the plurality of data records in the dataset, cause the at least one processor to: determine the value of each feature of the group of features of the plurality of features in each data record of the plurality of data records in the dataset; and wherein the one or more instructions that cause the at least one processor to replace the original value of the at least one feature in each data record of the plurality of data records in the dataset with the average value of the values of the at least one feature in each data record of the plurality of data records in the dataset, cause the at least one processor to: replace the original value of each feature of the group of features in each data record of the plurality of data records in the dataset with the average value of the values of each feature of the group of features in each data record of the plurality of data records in the dataset.

Clause 19: The computer program product of any of clauses 16-18, wherein the at least one feature is a first group of features, and wherein the one or more instructions that cause the at least one processor to determine the metric of model performance of the machine learning model based on the dataset that includes the original value of the at least one feature in each data record of the plurality of data records in the dataset replaced with the average value of the values of the at least one feature in each data record of the plurality of data records in the dataset, cause the at least one processor to: determine a first metric of model performance of the machine learning model based on the dataset that includes the original value of each feature of the first group of features in each data record of the plurality of data records in the dataset replaced with the average value of the values of each feature of the first group of features in each data record of the plurality of data records in the dataset; and wherein the one or more instructions further cause the at least one processor to: determine a second metric of model performance of the machine learning model based on the dataset that includes an original value of each feature of a second group of features in each data record of the plurality of data records in the dataset replaced with an average value of values of each feature of a second group of features in each data record of the plurality of data records in the dataset; and wherein the first group of features includes a group of features that is different than a group of features included in the second group of features.

Clause 20: The computer program product of any of clauses 16-19, wherein the one or more instructions further cause the at least one processor to: determine whether the metric of model performance of the machine learning model based on the average value of the values of the subset of features satisfies a threshold value of a metric of model performance of the machine learning model; and wherein the threshold value of the metric of model performance of the machine learning model is an evaluation result of the machine learning model using the dataset that includes the original value of each feature of the group of features in each data record of the plurality of data records in the dataset.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of non-limiting embodiments or aspects are explained in greater detail below with reference to the exemplary embodiments that are illustrated in the accompanying schematic figures, in which:

FIG. 1 is a diagram of a non-limiting aspect or embodiment of a system for identifying the feature importance of a feature of a machine learning model;

FIG. 2 is a diagram of a non-limiting aspect or embodiment of components of one or more devices and/or one or more systems of FIG. 1;

FIG. 3 is a flowchart of a non-limiting aspect or embodiment of a process for identifying the feature importance of a feature of a machine learning model; and

FIGS. 4A-4E are diagrams of a non-limiting embodiment of an implementation of a process for identifying the feature importance of a feature of a machine learning model.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively send information to the second unit. As another example, a first unit may be in communication with a second unit if at least one intermediary unit (e.g., a third unit located between the first unit and the second unit) processes information received from the first unit and sends the processed information to the second unit. In some non-limiting embodiments, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions such as such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “account identifier” may include one or more types of identifiers associated with an account (e.g., a PAN associated with an account, a card number associated with an account, a payment card number associated with an account, a token associated with an account, and/or the like). In some non-limiting embodiments, an issuer may provide an account identifier (e.g., a PAN, a token, and/or the like) to a user (e.g., an account holder) that uniquely identifies one or more accounts associated with that user. The account identifier may be embodied on a payment device (e.g., a physical instrument used for conducting payment transactions, such as a payment card, a credit card, a debit card, a gift card, and/or the like) and/or may be electronic information communicated to the user that the user may use for electronic payment transactions. In some non-limiting embodiments, the account identifier may be an original account identifier, where the original account identifier was provided to a user at the creation of the account associated with the account identifier. In some non-limiting embodiments, the account identifier may be a supplemental account identifier, which may include an account identifier that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of account identifier. Account identifiers may be alphanumeric, any combination of characters and/or symbols, and/or the like.

As used herein, the term “token” may refer to an account identifier of an account that is used as a substitute or replacement for another account identifier, such as a PAN. Tokens may be associated with a PAN or other original account identifier in one or more data structures (e.g., one or more databases) such that they may be used to conduct a payment transaction without directly using an original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the PAN or the other account identifiers. In some examples, an account identifier, such as a PAN, may be associated with a plurality of tokens for different uses or different purposes.

As used herein, the term “merchant” may refer to one or more entities (e.g., operators of retail businesses) that provide goods, services, and/or access to goods and/or services, to a user (e.g., a customer, a consumer, and/or the like) based on a transaction such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “point-of-sale (POS) device” may refer to one or more electronic devices, which may be used by a merchant to conduct a transaction (e.g., a payment transaction) and/or process a transaction. Additionally or alternatively, a POS device may include peripheral devices, card readers, scanning devices (e.g., code scanners and/or the like), Bluetooth® communication receivers, near-field communication (NFC) receivers, radio frequency identification (RFID) receivers, and/or other contactless transceivers or receivers, contact-based receivers, payment terminals, and/or the like.

As used herein, the term “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments, a POS system (e.g., a merchant POS system) may include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. In some non-limiting embodiments, a transaction service provider may include a credit card company, a debit card company, a payment network such as Visa®, MasterCard®, American Express®, or any other entity that processes transaction. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the term “payment device” may refer to a payment card (e.g., a credit or debit card), a gift card, a smart card (e.g., a chip card, an integrated circuit card, and/or the like), smart media, a payroll card, a healthcare card, a wristband, a machine-readable medium containing account information, a keychain device or fob, an RFID transponder, a retailer discount or loyalty card, and/or the like. The payment device may include a volatile or a non-volatile memory to store information (e.g., an account identifier, a name of the account holder, and/or the like).

As used herein, the term “computing device” may refer to one or more electronic devices that are configured to directly or indirectly communicate with or over one or more networks. In some non-limiting embodiments, a computing device may include a mobile device. A mobile device may include a smartphone, a portable computer, a wearable device (e.g., watches, glasses, lenses, clothing, and/or the like), a personal digital assistant (PDA), and/or other like devices. In some non-limiting embodiments, a computing device may include a server, a desktop computer, and/or the like.

As used herein, the terms “client” and “client device” may refer to one or more computing devices, such as processors, storage devices, and/or similar computer components, that access a service made available by a server. In some non-limiting embodiments, a “client device” may refer to one or more devices that facilitate payment transactions, such as one or more POS devices used by a merchant. In some non-limiting embodiments, a client device may include a computing device configured to communicate with one or more networks and/or facilitate payment transactions such as, but not limited to, one or more desktop computers, one or more mobile devices, and/or other like devices. Moreover, a “client” may also refer to an entity, such as a merchant, that owns, utilizes, and/or operates a client device for facilitating payment transactions with a transaction service provider.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or clients.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

In some non-limiting embodiments, computer-implemented methods, systems, and computer program products are disclosed. For example, a computer implemented method for determining the feature importance of a feature of a machine learning model may include determining a plurality of features of a dataset associated with a machine learning model that has been trained, determining a value of at least one feature of the plurality of features in each data record of a plurality of data records in the dataset, calculating an average value of the values of the at least one feature in each data record of the plurality of data records in the dataset, replacing an original value of the at least one feature in each data record of the plurality of data records in the dataset with the average value of the values of the at least one feature in each data record of the plurality of data records in the dataset, and determining a metric of model performance of the machine learning model based on the dataset that includes the original value of the at least one feature in each data record of the plurality of data records in the dataset replaced with the average value of the values of the at least one feature in each data record of the plurality of data records in the dataset.

In this way, non-limiting embodiments of the present disclosure may allow for determining feature importance of at least one feature of a machine learning model independent of re-training the machine learning model for each feature of a plurality of features in a dataset. In addition, non-limiting embodiments of the present disclosure may more accurately determine feature importance of the at least one feature of the machine learning model independent than re-training the machine learning model more than once for each feature of the plurality of features in the dataset to determine the importance of a feature. Further, by removing features that are determined to be less important than other features before training a machine learning model, the accuracy of a machine learning model may be improved, while simultaneously reducing the runtime for one or more actions performed using the machine learning model.

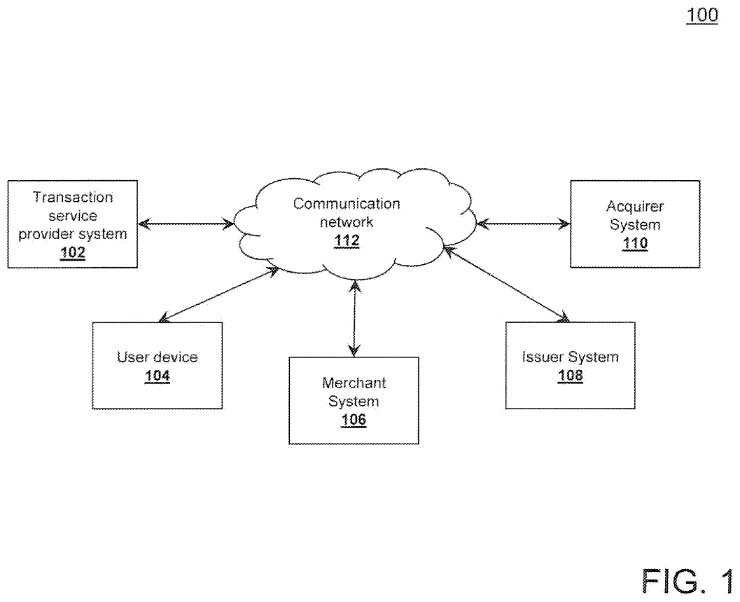

Referring now to FIG. 1, FIG. 1 is a diagram of a non-limiting embodiment of an environment 100 in which devices, systems, methods, and/or products described herein may be implemented. As shown in FIG. 1, environment 100 includes transaction service provider system 102, user device 104, merchant system 106, issuer system 108, and acquirer system 110. Transaction service provider system 102, user device 104, merchant system 106, issuer system 108, and acquirer system 110 may interconnect (e.g., establish a connection to communicate and/or the like) via wired connections, wireless connections, or a combination of wired and wireless connections.

Transaction service provider system 102 may include one or more devices capable of being in communication with user device 104, merchant system 106, issuer system 108, and/or acquirer system 110 via communication network 112. For example, transaction service provider system 102 may include a server (e.g., a transaction processing server), a group of servers (e.g., a group of transaction processing servers), and/or other like devices. In some non-limiting embodiments, transaction service provider system 102 may be associated with a transaction service provider, as described herein.

User device 104 may include one or more devices capable of being in communication with transaction service provider system 102, merchant system 106, issuer system 108, and/or acquirer system 110 via communication network 112. For example, user device 104 may include one or more computing devices, such as one or more mobile devices, one or more smartphones, one or more wearable devices, one or more personal digital assistants (PDAs), one or more servers, and/or the like. In some non-limiting embodiments, user device 104 may communicate via a short-range wireless communication connection (e.g., a wireless communication connection for communicating information in a range between 2 to 3 centimeters to 5 to 6 meters, such as a near-field communication (NFC) communication connection, a radio frequency identification (RFID) communication connection, a Bluetooth® communication connection, and/or the like). In some non-limiting embodiments, user device 104 may be associated with a merchant, as described herein.

Merchant system 106 may include one or more devices capable of being in communication with transaction service provider system 102, user device 104, issuer system 108, and/or acquirer system 110 via communication network 112. For example, merchant system 106 may include one or more computing devices, such as one or more mobile devices, one or more smartphones, one or more wearable devices, one or more PDAs, one or more servers, and/or the like. In some non-limiting embodiments, merchant system 106 may communicate via a short-range wireless communication connection. In some non-limiting embodiments, merchant system 106 may be associated with a merchant, as described herein.

Issuer system 108 may include one or more devices capable of being in communication with transaction service provider system 102, user device 104, merchant system 106, and/or acquirer system 110 via communication network 112. For example, issuer system 108 may include one or more computing devices, such one or more servers and/or other like devices. In some non-limiting embodiments, issuer system 108 may be associated with an issuer institution that issued a payment account and/or instrument (e.g., a credit account, a debit account, a credit card, a debit card, and/or the like) to a user.

Acquirer system 110 may include one or more devices capable of being in communication with transaction service provider system 102, user device 104, merchant system 106, issuer system 108 via communication network 112. For example, acquirer system 110 may include one or more computing devices, such one or more servers and/or other like devices. In some non-limiting embodiments, acquirer system 110 may be associated with an acquirer, as described herein.

Communication network 112 may include one or more wired and/or wireless networks. For example, communication network 112 may include a cellular network (e.g., a long-term evolution (LTE) network, a third generation (3G) network, a fourth generation (4G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of systems and/or devices shown in FIG. 1 are provided as an example. There may be additional systems and/or devices, fewer systems and/or devices, different systems and/or devices, or differently arranged systems and/or devices than those shown in FIG. 1. Furthermore, two or more systems and/or devices shown in FIG. 1 may be implemented within a single system or a single device, or a single system or a single device shown in FIG. 1 may be implemented as multiple, distributed systems or devices. Additionally or alternatively, a set of systems or a set of devices (e.g., one or more systems, one or more devices) of environment 100 may perform one or more functions described as being performed by another set of systems or another set of devices of environment 100.

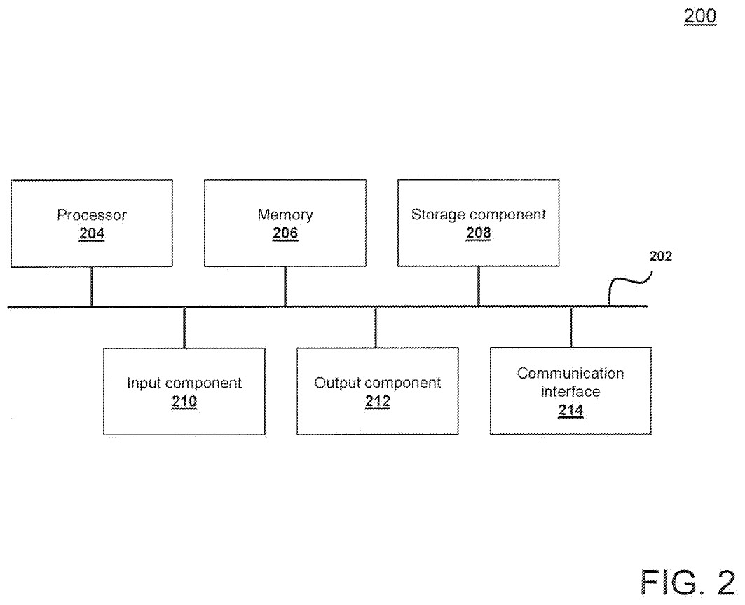

Referring now to FIG. 2, FIG. 2 is a diagram of example components of device 200. Device 200 may correspond to transaction service provider system 102 (e.g., one or more devices of transaction service provider system 102), user device 104, merchant system 106 (e.g., one or more devices of merchant system 106), issuer system 108 (e.g., one or more devices of issuer system 108), and/or acquirer system 110 (e.g., one or more devices of acquirer system 110). In some non-limiting aspects or embodiments, transaction service provider system 102, user device 104, merchant system 106, issuer system 108, and/or acquirer system 110 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting aspects or embodiments, processor 204 may be implemented in hardware, software, or a combination of hardware and software. For example, processor 204 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like) that can be programmed to perform a function. Memory 206 may include random access memory (RAM), read-only memory (ROM), and/or another type of dynamic or static storage device (e.g., flash memory, magnetic memory, optical memory, and/or the like) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, and/or the like). Additionally or alternatively, input component 210 may include a sensor for sensing information (e.g., a global positioning system (GPS) component, an accelerometer, a gyroscope, an actuator, and/or the like). Output component 212 may include a component that provides output information from device 200 (e.g., a display, a speaker, one or more light-emitting diodes (LEDs), and/or the like).

Communication interface 214 may include a transceiver-like component (e.g., a transceiver, a separate receiver and transmitter, and/or the like) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a WiFi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database and/or the like). Device 200 may be capable of retrieving information from, storing information in, or searching information stored in the data storage or one or more data structures in memory 206 and/or storage component 208. For example, the information may include encryption data, input data, output data, transaction data, account data, or any combination thereof.

The number and arrangement of components shown in FIG. 2 are provided as an example. In some non-limiting aspects or embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

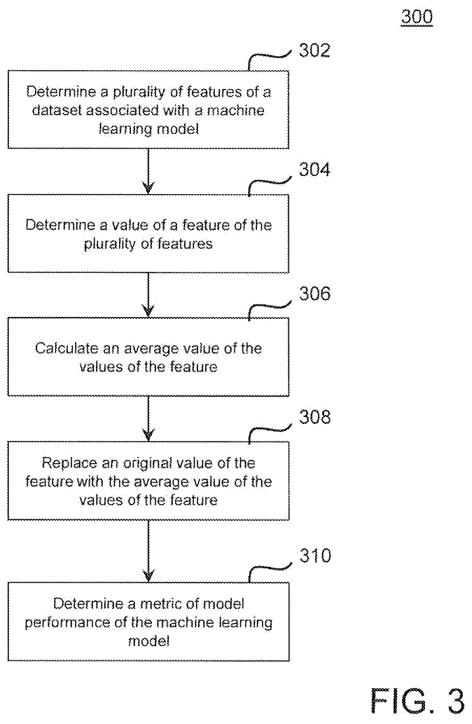

Referring now to FIG. 3, illustrated is a flowchart of a non-limiting embodiment of a process 300 for identifying the feature importance of a feature of a machine learning model. In some non-limiting aspects or embodiments, one or more of the functions described with respect to process 300 may be performed (e.g., completely, partially, and/or the like) by transaction service provider system 102. In some non-limiting embodiments, one or more of the steps of process 300 may be performed (e.g., completely, partially, and/or the like) by another device or a group of devices separate from and/or including user device 104, merchant system 106, issuer system 108, and/or acquirer system 110.

As shown in FIG. 3, at step 302, process 300 may include determining a plurality of features of a dataset associated with a machine learning model. For example, transaction service provider system 102 may determine a plurality of features of a dataset (e.g., a plurality of feature of a data record in a dataset) associated with a machine learning model. In some non-limiting embodiments, the dataset may be or may have been used to train the machine learning model (e.g., prior to, during, and/or after the dataset is used to train the machine learning model). For example, transaction service provider system 102 may train the machine learning model based on the dataset associated with the machine learning model. In some non-limiting embodiments, transaction service provider system 102 may determine the plurality of features of the dataset based on data included in the dataset (e.g., based on one or more data records included in the dataset).

As shown in FIG. 3, at step 304, process 300 may include determining a value of a feature of the plurality of features. For example, transaction service provider system 102 may determine a value of at least one feature (e.g., a single feature, a subset of features, all features, and/or the like) of the plurality of features. In some non-limiting embodiments, transaction service provider system 102 may determine the value of the at least one feature of the plurality of features prior to, during, and/or after the machine learning model associated with the dataset is trained. In some non-limiting embodiments, transaction service provider system 102 may determine the value of a feature of the plurality of features for one or more data records. For example, transaction service provider system 102 may determine the value of the feature of the plurality of features for one or more data records included in the dataset based on data included in the data records in the dataset. In another example, transaction service provider system 102 may determine the values of the at least one feature for one or more data records included in the dataset based on data included in the data records in the dataset.

In some non-limiting embodiments, transaction service provider system 102 may determine one or more groups of features of the plurality of features of the dataset associated with the machine learning model. For example, transaction service provider system 102 may determine that at least one feature included in the dataset (e.g., features associated with one or more data records included in the dataset) are associated with one or more other features as a group of features. In such an example, transaction service provider system 102 may determine the one or more groups of features by selecting the at least one feature included in the one or more groups of features randomly (e.g., transaction service provider system 102 may determine the group of features by associating the at least one feature with the other at least one feature at random).

As shown in FIG. 3, at step 306, process 300 may include calculating an average value of the values of the feature. For example, transaction service provider system 102 may calculate an average value of values of at least one feature associated with each data record of the plurality of data records in the dataset. In such an example, transaction service provider system 102 may calculate the average value of the values of the at least one feature by summing (e.g., adding) the values of the at least one feature in each data record of the plurality of data records and dividing the sum of the values by a number of data records in the dataset. In another example, transaction service provider system 102 may calculate the average value of the values of the at least one feature by selecting a median value from among the values of the at least one feature.

In some non-limiting embodiments, transaction service provider system 102 may calculate an average value for a feature for a group of features. For example, transaction service provider system 102 may calculate the average value of the values of a feature associated with each data record of the plurality of data records in the dataset. In such an example, transaction service provider system 102 may calculate the average value of the values of the at least one feature by adding up the values of the at least one feature in each data record of a plurality of data records in a dataset and dividing the added up values by a number of data records included in the plurality of data records. In another example, transaction service provider system 102 may calculate the average value of the values of the at least one feature by selecting a median value from among the values of the features associated with each data record of the plurality of data records. In an example, transaction service provider system 102 may determine an average value based on one or more predetermined values associated with the features (e.g., default values and/or the like). In some non-limiting embodiments or aspects, transaction service provider system 102 may calculate the average value of the values of the at least one feature by selecting a value that occurs more than another value. For example, where values of a feature are associated with a merchant type (e.g., a merchant that primarily sells groceries, a merchant that primarily sells electronics, and/or the like), transaction service provider system 102 may select the value associated with the merchant type that is specified by the one or more data records in one or more datasets.

As shown in FIG. 3, at step 308, process 300 may include replacing an original value of the feature with the average value of the values of the feature. For example, transaction service provider system 102 may replace an original value of the at least one feature in each data record of the plurality of data records in the dataset with the average value of the values of the at least one feature in each data record of the plurality of records in the dataset. In such an example, transaction service provider system 102 may replace the original value of the at least one feature in each data record of the plurality of data records in the dataset with the average value of the values of the at least one feature in each data record of the plurality of records based on (e.g., after and/or in response to) transaction service provider system 102 calculating the average value of the values of the at least one feature in each data record of the plurality of data records in the dataset. In an example, transaction service provider system 102 may replace an original value of at least one feature of a group of features in each data record of the plurality of data records in the dataset with the average value of the values of the at least one feature of the group of features in each data record of the plurality of records in the dataset. In such an example, transaction service provider system 102 may replace the original value of the at least one feature of the group of features in each data record of the plurality of data records in the dataset with the average value of the values of the at least one feature of the group of features in each data record of the plurality of records based on (e.g., after and/or in response to) transaction service provider system 102 calculating the average value of the values of the at least one feature in each data record of the plurality of data records in the dataset. In another example, transaction service provider system 102 may replace an original value of each of the features in each data record of the plurality of data records in the dataset with the average value of the values of each of the features in each data record of the plurality of records in the dataset. In such an example, transaction service provider system 102 may replace the original value of each of the features in each data record of the plurality of data records in the dataset with the average value of the values of each of the features in each data record of the plurality of records based on (e.g., after and/or in response to) transaction service provider system 102 calculating the average value of the values of the at least one feature in each data record of the plurality of data records in the dataset.

As shown in FIG. 3, at step 310, process 300 may include determining a metric of model performance of the machine learning model. For example, transaction service provider system 102 may determine a metric of model performance for the machine learning model. In some non-limiting embodiments, transaction service provider system 102 may determine the metric of model performance for the machine learning model based on (e.g., after and/or in response to) replacing one or more original values of the at least one feature in each data record of the plurality of data records in the dataset with the average value of the values of the at least one feature in each data record of the plurality of data records in the dataset. For example, transaction service provider system 102 may determine the metric of model performance for the machine learning model based on the dataset including the one or more data records, where the original value of the at least one feature in each data record of the one or more data records included in the dataset is replaced by transaction service provider system 102 with the average value of the values of the at least one feature in each data record of the plurality of data records in the dataset.

In another example, transaction service provider system 102 may determine the metric of model performance for the machine learning model based on the dataset including the one or more data records, where the original value of the at least one feature of a group of features in each data record of the one or more data records included in the dataset is replaced by transaction service provider system 102 with the average value of the values of the at least one feature of a group of features in each data record of the plurality of data records in the dataset.

In another example, transaction service provider system 102 may determine the metric of model performance for the machine learning model based on the dataset including the one or more data records, where the original value of the at least one feature of each of the features in each data record of the one or more data records included in the dataset is replaced by transaction service provider system 102 with the average value of the values of the at least one feature of each of the features in each data record of the plurality of data records in the dataset. In some non-limiting embodiments, transaction service provider system 102 may determine the metric of model performance of the machine learning model based on the dataset independent of retraining the machine learning model (e.g., without retraining the machine learning model after determining the metric of model performance for one or more datasets).

In some non-limiting embodiments, transaction service provider system 102 may determine a metric of model performance for the machine learning model by providing one or more inputs to the machine learning model to cause the machine learning model to determine a prediction. For example, transaction service provider system 102 may provide one or more datasets to the machine learning model to cause the machine learning model to determine the prediction. In such an example, the prediction may be an evaluation result (e.g., a number representing the probability that a payment transaction is a fraudulent payment transaction). In such an example, transaction service provider system 102 may provide a dataset to the machine learning model where the original value of at least one feature (e.g., one feature, a group of features, all features, and/or the like) of each data record of the plurality of data records included in the dataset is replaced with the average value of the at least one feature in each data record of the plurality of data records included in the dataset.

In some non-limiting embodiments, transaction service provider system 102 may determine one or more threshold values of a metric of model performance of the machine learning model. For example, transaction service provider system 102 may determine a threshold value of a metric of model performance based on transaction service provider system 102 determining a metric of model performance for the machine learning model. In one example, transaction service provider system 102 may determine the threshold value of the metric of model performance for the machine learning model based on transaction service provider system 102 providing a dataset where the original value of the at least one feature of each of the features in each data record of the one or more data records included in the dataset is replaced by transaction service provider system 102 with the average value of the values of the at least one feature of each of the features in each data record of the plurality of data records in the dataset. In such an example, transaction service provider system 102 may receive a prediction from the machine learning model based on providing the dataset to the machine learning model, the prediction including an evaluation result that is associated with a threshold value of a metric of model performance. In another example, transaction service provider system 102 may determine the threshold value of the metric of model performance for the machine learning model based on transaction service provider system 102 providing a dataset where the original value of the at least one feature of each of the features of a group of features in each data record of the one or more data records included in the dataset is replaced by transaction service provider system 102 with the average value of the values of the at least one feature of each of the features of the group of features in each data record of the plurality of data records in the dataset. In such an example, transaction service provider system 102 may receive a prediction from the machine learning model based on providing the dataset to the machine learning model, the prediction including an evaluation result that is associated with a threshold value of a metric of model performance.

In some non-limiting embodiments, transaction service provider system 102 may determine the threshold value of the metric of model performance for the machine learning model based on transaction service provider system 102 providing a dataset where the original value of each of the features in each data record of the one or more data records included in the dataset is replaced by transaction service provider system 102 with the average value of the values of each of the features in each data record of the plurality of data records in the dataset. In such an example, transaction service provider system 102 may receive a prediction from the machine learning model based on providing the dataset to the machine learning model, where the prediction includes an evaluation result that is associated with a threshold value of a metric of model performance.

In some non-limiting embodiments, transaction service provider system 102 may determine whether the metric of model performance of the machine learning model satisfies a threshold value of a metric of model performance of the machine learning model. For example, transaction service provider system 102 may determine whether the metric of model performance of the machine learning model satisfies a threshold value of the metric of model performance of the machine learning model by comparing the metric of model performance of the machine learning model to one or more threshold values of a metric of model performance of the machine learning model.

In some non-limiting embodiments, transaction service provider system 102 may determine a first metric of model performance of the machine learning model and a second metric of model performance of the machine learning model. For example, transaction service provider system 102 may determine the first metric of model performance of the machine learning model based on a dataset that includes the original value of a first group of features (e.g., a first group including at least one feature of the at least one feature) in each data record of the plurality of data records in the dataset replaced with the average value of the values of each feature of the first group of features in each data record of the plurality of data records in the dataset. Transaction service provider system 102 may then determine the second metric of model performance of the machine learning model based on a dataset that includes the original value of a second group of features (e.g., a second group including at least one feature of the at least one feature) in each data record of the plurality of data records in the dataset replaced with the average value of the values of each feature of the second group of features in each data record of the plurality of data records in the dataset. In some non-limiting embodiments, the first group of features may be different from the second group of features (e.g., the first group of features may include at least one feature that are not included in the at least one feature of the second group of features, the first group of features may include at least one feature that are different from at least one feature of the second group of features, and/or the first group of features may not include at least one feature that are included in the at least one feature of the second group of features).

In some non-limiting embodiments, transaction service provider system 102 may determine whether the first metric of model performance and/or the second metric of model performance satisfies a threshold value of a metric of model performance of the machine learning model. For example, transaction service provider system 102 may determine whether the first metric of model performance of the machine learning model satisfies a threshold value of a metric of model performance of the machine learning model, where the first metric of model performance is determined by transaction service provider system 102 based on the average value of the values of each feature of the first group of features. Transaction service provider system 102 may then determine whether the second metric of model performance of the machine learning model satisfies a threshold value of a metric of model performance of the machine learning model, where the second metric of model performance is determined by transaction service provider system 102 based on the average value of the values of each feature of the second group of features.

In some non-limiting embodiments, transaction service provider system 102 may compare the first metric of model performance to the second metric of model performance. For example, transaction service provider system 102 may compare the first metric of model performance to the second metric of model performance based on transaction service provider system 102 determining the first metric of model performance and the second metric of model performance. In such an example, transaction service provider system 102 may select the first metric of model performance or the second metric of model performance based on determining whether the first metric of model performance indicates better model performance, the same model performance, or worse model performance than the second metric of model performance.

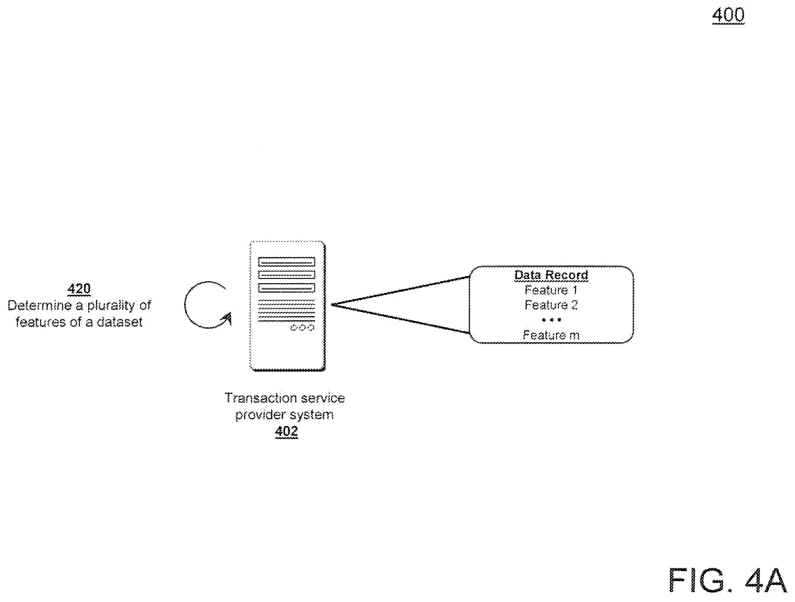

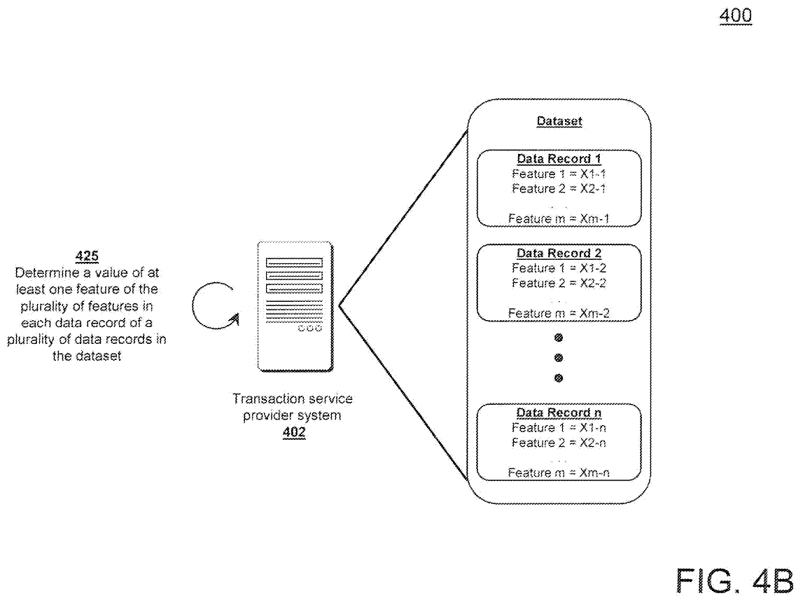

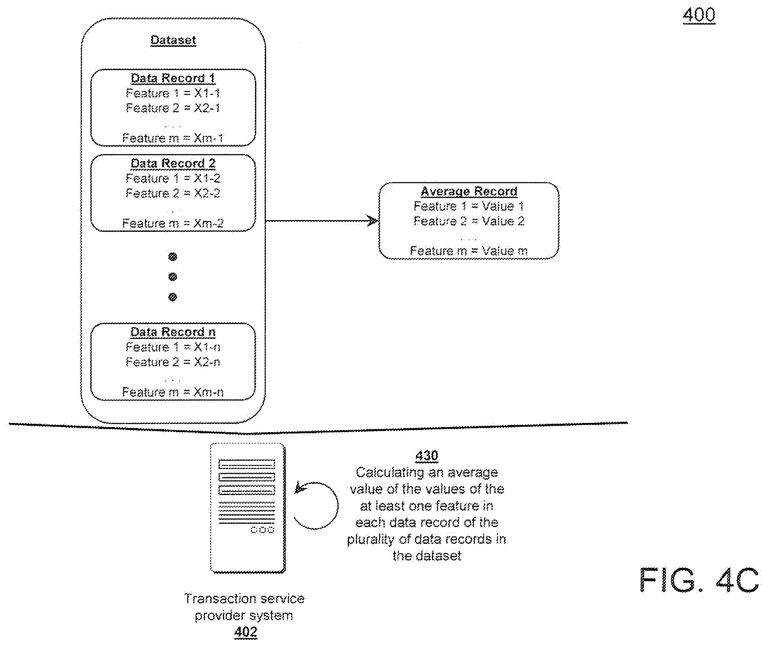

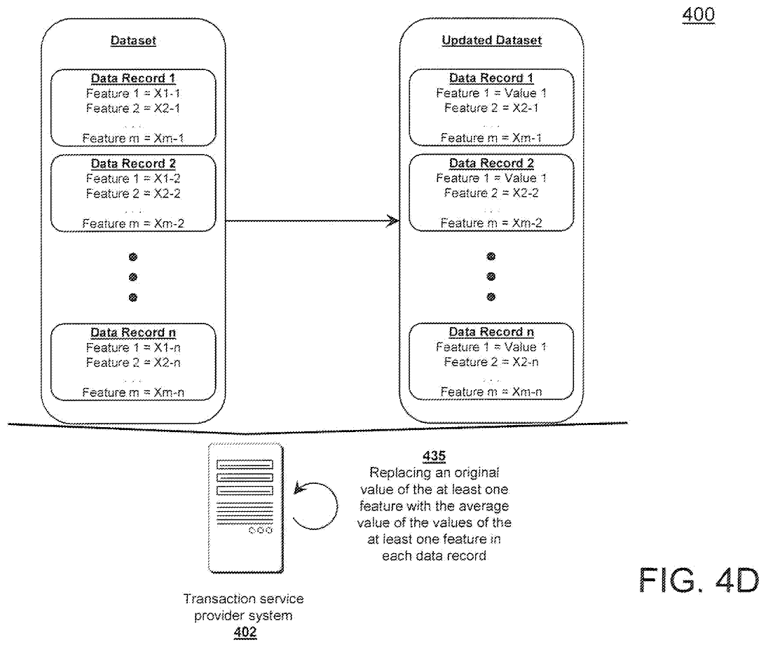

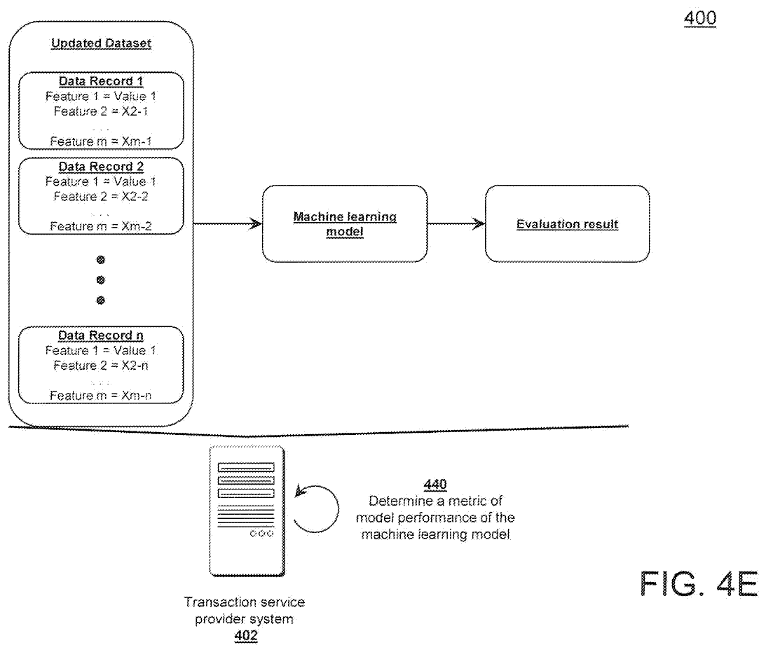

Referring now to FIGS. 4A-4E, illustrated is a non-limiting embodiment of an implementation 400 of a process for determining the feature importance of a feature of a machine learning model. As illustrated in FIGS. 4A-4E, implementation 400 may include transaction service provider system 402 which may be the same or similar to transaction service provider system 102.

As shown by reference number 420 in FIG. 4A, transaction service provider system 402 may determine a plurality of features of a dataset. For example, transaction service provider system 402 may determine the plurality of features of the dataset (e.g., Feature 1, Feature 2, . . . , Feature m) based on a plurality of data records included in the dataset (e.g., Data Record 1, Data Record 2, . . . , Data Record n). In such an example, transaction service provider system 402 may determine that one or more parameters of each of the data records are associated with at least one feature. For example, transaction service provider system 402 may determine that one or more parameters of each of the data records are associated with at least one feature from among a plurality of features. In such an example, the at least one feature of a dataset may correspond to one or more features of another dataset. In another example, the at least one feature of the dataset may not correspond to one or more features of the another dataset. In some non-limiting embodiments, transaction service provider system 402 may derive one or more values associated with the at least one feature based on the values associated with the one or more parameters of each of the data records.

In some non-limiting embodiments, the dataset may be used to train a machine learning model. For example, transaction service provider system 402 may provide the dataset to a machine learning model to train the machine learning model. In another example, transaction service provider system 402 may receive data associated with the machine learning model after another system (e.g., merchant system 106, issuer system 108, acquirer system 110, and/or the like) trains the machine learning model using the dataset.

As shown by reference number 425 in FIG. 4B, transaction service provider system 402 may determine a value of at least one feature of the plurality of features in each data record of a plurality of data records in the dataset. For example, transaction service provider system 402 may determine the value of the at least one feature of the plurality of features of the one or more data records included in the dataset based on values associated with one or more parameters of each of the data records of the dataset.

As shown by reference number 430 in FIG. 4C, transaction service provider system 402 may calculate an average value of the values of the at least one feature in each data record of the plurality of data records in the dataset. For example, transaction service provider system 402 may calculate an average value of the values of the at least one feature in each data record of the plurality of data records in the dataset by determining an average value for each feature of the at least one feature included in the plurality of data records in the dataset. In one example, the average value may be a mean value calculated based on values of each feature of the at least one feature included in the plurality of data records in the dataset. In another example, the average value may be a median value calculated based on values of each feature of the at least one feature included in the plurality of data records.

As shown by reference number 435 in FIG. 4D, transaction service provider system 402 may replace an original value of the at least one feature with the average value of the values of the at least one feature in each data record. For example, transaction service provider system 402 may replace an original value (e.g., one or more original values) of the at least one feature of each of the data records of the plurality of data records of the dataset with the average value that is associated with the at least one feature in each of the data records of the plurality of data records in the dataset. In some non-limiting embodiments, transaction service provider system 402 may replace a plurality of original values of the at least one feature of each of the data records of the plurality of data records of the dataset with the average value that is associated with the at least one feature in each of the data records of the plurality of data records in the dataset.

As shown by reference number 440 in FIG. 4E, transaction service provider system 402 may determine a metric of model performance of the machine learning model. For example, transaction service provider system 402 may determine a metric of model performance of the machine learning model by providing the dataset including the original value of the at least one feature in each data record of the plurality of data records in the dataset replaced with the average value of the values of the at least one feature in each data record of the plurality of data records as input to the machine learning model. In such an example, transaction service provider system 402 may receive, as output from the machine learning model, an evaluation result. The evaluation result may be a prediction determined by transaction service provider system 402 based on transaction service provider system 402 providing the dataset including the original value of the at least one feature in each data record of the plurality of data records in the dataset replaced with the average value of the values of the at least one feature in each data record of the plurality of data records as input to the machine learning model. Transaction service provider system 402 may then determine the metric of model performance based on the evaluation result. For example, transaction service provider system 402 may determine whether the evaluation result satisfies a threshold value of the metric of model performance of the machine learning model (e.g., whether the evaluation result is less than, equal to, or greater than the threshold value).

In some non-limiting embodiments or aspects, transaction service provider system 402 may calculate a score for one or more features. For example, transaction service provider system 402 may calculate a score for one or more features of the plurality of features based on determining one or more evaluation results. In an example, transaction service provider system 402 may determine the score for a feature based on replacing the value associated with the feature included in the plurality of features with the average value associated with the features and, after replacing the original value with the average value, determining an evaluation result for the plurality of features. Transaction service provider system 402 may then determine a score for the feature based on determining the evaluation result for the plurality of features where the original value associated with the feature is replaced with the average value associated with the feature.

In some non-limiting embodiments or aspects, transaction service provider system 402 may determine a score (e.g., a score that indicates the relative effect one feature may have when provided to the machine learning model than another feature in determining whether a fraudulent transaction is indeed a fraudulent transaction) associated with each of the features of the plurality of features. For example, transaction service provider system 402 may determine a score for each of the features of the plurality of features and transaction service provider system 402 may determine that one or more features of the plurality of features are more likely to cause the machine learning model to identify a fraudulent transaction than one or more other features of the plurality of features when provided as input to the machine learning model (e.g., that by replacing the original values of the one or more features with average values, the machine learning model was less likely to correctly predict that a transaction was a fraudulent transaction and, as a result, that the feature values associated with that feature are more likely to cause the machine learning model to correctly predict that the transaction was a fraudulent transaction) based on comparing the scores for each of the features of the plurality of features to one another. In some non-limiting embodiments or aspects, transaction service provider system 402 may drop (e.g., discard) one or more features from among the plurality of features based on determining the score for the one or more features. For example, transaction service provider system 402 may determine that the one or more features are associated with scores that do or do not satisfy a threshold score for a feature and, based on determining that the one or more features do or do not satisfy the threshold score, may drop the one or more features from among the plurality of features.

In some non-limiting embodiments or aspects, transaction service provider system 402 may determine the scores for the one or more features based on transaction service provider system 402 determining evaluation results associated with the one or more features. For example, transaction service provider system 402 may determine the score associated with each features based on transaction service provider system 402 determining an evaluation for the first group of features, where the original value of the feature is replaced with the average value of the feature. Transaction service provider system 402 may then determine the score for the features based on the evaluation result for the first group of features where the original values of the one or more values of each feature of the one or more sub-groups of features are replaced with corresponding average values.

In some non-limiting embodiments or aspects, transaction service provider system 402 may determine a score associated with one or more features based on transaction service provider system 402 determining a group score associated with one or more groups of features. For example, transaction service provider system 402 may determine a first group of features during a first round from the plurality of features. In such an example, transaction service provider system 402 may determine one or more sub-groups of features of the first group of features. In an example, transaction service provider system 402 may determine a first sub-group of features, a second sub-group of features, and a third sub-group of features, with each sub-group of features including one or more features from the first group of features. In some non-limiting embodiments or aspects, transaction service provider system 402 may determine a first sub-group of features, a second sub-group of features, and a third sub-group of features, where the features associated with the first sub-group of features, the second sub-group of features, and the third sub-group of features include one or more features that are included in one or more other sub-groups of features. Additionally, or alternatively, transaction service provider system 402 may determine the first sub-group of features, the second sub-group of features, and the third sub-group of features, where the features associated with the first sub-group of features, the second sub-group of features, and the third sub-group of features do not include one or more features that are included in the one or more other sub-groups of features.

In some non-limiting embodiments or aspects, transaction service provider system 402 may determine group scores for the one or more sub-groups of features. For example, transaction service provider system 402 may determine group scores for the one or more sub-groups of features based on transaction service provider system 402 determining evaluation results associated with the one or more sub-groups of features during the first round. For example, transaction service provider system 402 may replace one or more original values of each feature of the one or more sub-groups of features that are included in the first group of features with the average value of each feature of the one or more sub-groups of features. Transaction service provider system 402 may then determine the group score for the one or more sub-groups of features based on the evaluation result for the first group of features where the original values of each feature of the one or more sub-groups of features are replaced with corresponding average values.

In some non-limiting embodiments or aspects, transaction service provider system 402 may determine a second group of features for a second round based on the group scores of the one or more sub-groups of features of the first group of features. For example, transaction service provider system 402 may select one or more features from the first group of features to include in the second group of features based on the group scores associated with the sub-groups of features of the first group of features. In such an example, transaction service provider system 402 may compare the group scores associated with the sub-groups of features of the first group of features and transaction service provider system 402 may drop (e.g., discard) the features included in one or more sub-groups of features from the first group of features when determining the second group of features based on comparing the group scores of the sub-groups of features of the first group of features. In some non-limiting embodiments or aspects, transaction service provider system 402 may drop the features included in one or more sub-groups of features that are associated with a lower sub-group score than other sub-group scores of features associated with higher sub-group scores, the lower score indicating that the features included in the one or more sub-groups of features that are dropped are, if included in a group of features, less likely to cause the machine learning model to correctly identify a fraudulent transaction. In some non-limiting embodiments or aspects, transaction service provider system 402 may then determine group scores for one or more sub-groups of features for the second group of features during a second round similar to transaction service provider system 402 determining the group scores of the sub-groups of features associated with the first group of features.

In some non-limiting embodiments or aspects, transaction service provider system 402 may determine a second group of features for a second round without dropping features from the first round. For example, transaction service provider system 402 may determine the second group of features based on shuffling one or more features included in the one or more sub-groups of features. In such an example, transaction service provider system 402 may determine group scores for the one or more sub-groups of features for the second group of features during the second round similar to transaction service provider system 402 determining the group scores of the sub-groups of features associated with the first group of features.

In some non-limiting embodiments or aspects, transaction service provider system 402 may determine a score associated with a feature based on one or more group scores associated with one or more groups of features. For example, transaction service provider system 402 may determine a score associated with a feature based on one or more group scores associated with one or more groups of features where, when transaction service provider system 402 determined the group score for the one or more groups of features, transaction service provider system 402 replaced the original value of the feature with the average value of the feature. In such an example, transaction service provider system 402 may aggregate the group scores of each group of features where the original value of the feature was replaced with the average value for the feature and transaction service provider system 402 may determine the score for the feature based on the aggregation of the group scores for each group of features where the original value of the feature was replaced with the average value for the feature.

In some non-limiting embodiments or aspects, transaction service provider system 402 may determine an amount of features to include in one or more sub-groups. For example, transaction service provider system 402 may determine that a group of features will include one or more sub-groups of features based on the amount of features included in the group of features. In this way, transaction service provider system 402 may manage the runtime when calculating a score for a feature, a group of features, and/or the like.

Although the above systems, methods, and computer program products have been described in detail for the purpose of illustration based on what is currently considered to be the most practical and preferred embodiments or aspects, it is to be understood that such detail is solely for that purpose and that the present disclosure is not limited to the described embodiments or aspects but, on the contrary, is intended to cover modifications and equivalent arrangements that are within the spirit and scope of the appended claims. For example, it is to be understood that the present disclosure contemplates that, to the extent possible, at least one feature of any embodiment or aspect can be combined with at least one feature of any other embodiment or aspect.

What is claimed is:

1. A computer implemented method for determining the feature importance of a feature of a machine learning model, the method comprising:
determining, with at least one processor, a plurality of features of a dataset associated with a machine learning model that has been trained, wherein the dataset was used to train the machine learning model;
determining, with at least one processor, a value of at least one feature of the plurality of features in each data record of a plurality of data records in the dataset;
calculating, with at least one processor, an average value of the values of the at least one feature in each data record of the plurality of data records in the dataset;
replacing, with at least one processor, an original value of the at least one feature in each data record of the plurality of data records in the dataset with the average value of the values of the at least one feature in each data record of the plurality of data records in the dataset; and
determining, with at least one processor, a metric of model performance of the machine learning model based on the dataset that includes the original value of the at least one feature in each data record of the plurality of data records in the dataset replaced with the average value of the values of the at least one feature in each data record of the plurality of data records in the dataset.

2. The method of claim 1, further comprising:
determining whether the metric of model performance of the machine learning model based on the average value of the values of the at least one feature satisfies a threshold value of the metric of model performance of the machine learning model.

3. The method of claim 2, wherein the threshold value of the metric of model performance of the machine learning model is an evaluation result of the machine learning model using the dataset that includes the original value of the at least one feature in each data record of the plurality of data records in the dataset.

4. The method of claim 1, wherein the at least one feature is a group of features, the method further comprising:
randomly selecting the group of features from the plurality of features.

5. The method of claim 4, wherein determining the value of the at least one feature of the plurality of features in each data record of the plurality of data records in the dataset comprises:
determining the value of each feature of the group of features of the plurality of features in each data record of the plurality of data records in the dataset; and
wherein replacing the original value of the at least one feature in each data record of the plurality of data records in the dataset with the average value of the values of the at least one feature in each data record of the plurality of data records in the dataset comprises:
replacing the original value of each feature of the group of features in each data record of the plurality of data records in the dataset with the average value of the values of each feature of the group of features in each data record of the plurality of data records in the dataset.

6. The method of claim 1, wherein the at least one feature is a first group of features, and wherein determining the metric of model performance of the machine learning model based on the dataset that includes the original value of the at least one feature in each data record of the plurality of data records in the dataset replaced with the average value of the values of the at least one feature in each data record of the plurality of data records in the dataset comprises:
determining a first metric of model performance of the machine learning model based on the dataset that includes the original value of each feature of the first group of features in each data record of the plurality of data records in the dataset replaced with the average value of the values of each feature of the first group of features in each data record of the plurality of data records in the dataset; the method further comprising:
determining a second metric of model performance of the machine learning model based on the dataset that includes an original value of each feature of a second group of features in each data record of the plurality of data records in the dataset replaced with an average value of values of each feature of a second group of features in each data record of the plurality of data records in the dataset;
wherein the first group of features includes a group of features that is different than a group of features included in the second group of features.

7. The method of claim 6, further comprising:
determining whether the first metric of model performance of the machine learning model based on the average value of the values of each feature of the first group of features satisfies a threshold value of a metric of model performance of the machine learning model; and
determining whether the second metric of model performance of the machine learning model based on the average value of the values of each feature of the second group of features satisfies the threshold value of a metric of model performance of the machine learning model.

8. The method of claim 2, wherein the metric of model performance of the machine learning model based on the average value of the values of the at least one feature is a first metric of model performance based on the average value of the values of a first feature, the method further comprising:
comparing the first metric of model performance to a second metric of model performance of the machine learning model based on an average value of values of a second feature;
determining whether the first metric of model performance indicates worse model performance than the second metric of model performance; and
selecting the first metric of model performance or the second metric of model performance based on determining whether the first metric of model performance indicates worse model performance than the second metric of model performance.

9. The method of claim 1, wherein determining the metric of model performance of the machine learning model based on the dataset that includes the original value of the at least one feature in each data record of the plurality of data records in the dataset replaced with the average value of the values of the at least one feature in each data record of the plurality of data records in the dataset comprises:
determining the metric of model performance of the machine learning model based on the dataset independent of re-training the machine learning model based on the dataset that includes the original value of the at least one feature in each data record of the plurality of data records in the dataset replaced with the average value of the values of the at least one feature in each data record of the plurality of data records in the dataset.

10. A system for determining the feature importance of a feature of a machine learning model, comprising:
at least one processor programmed or configured to:
determine a plurality of features in each data record of a plurality of data records in a dataset associated with a machine learning model that has been trained;
determine a value of a subset of features of the plurality of features in each data record;
calculate an average value of the values of the subset of features in each data record;
replace an original value of each feature in the subset of features in each data record with the average value of the values of the subset of features in each data record; and
determine a metric of model performance of the machine learning model based on the dataset that includes the original value of each feature in the subset of features in each data record replaced with the average value of the values of the subset of features in each data record.

11. The system of claim 10, wherein the at least one processor is further programmed or configured to:
determine whether the metric of model performance of the machine learning model based on the average value of the values of the subset of features satisfies a threshold value of a metric of model performance of the machine learning model; and
wherein the threshold value of the metric of model performance of the machine learning model is an evaluation result of the machine learning model using the dataset that includes the original value of the subset of features in each data record of the plurality of data records in the dataset.

12. The system of claim 10, wherein the at least one processor is further programmed or configured to:
randomly select the subset of features from the plurality of features.

13. The system of claim 10, wherein the at least one feature is a first group of features, and wherein when determining the metric of model performance of the machine learning model based on the dataset that includes the original value of the at least one feature in each data record of the plurality of data records in the dataset replaced with the average value of the values of the at least one feature in each data record of the plurality of data records in the dataset, the at least one processor is programmed or configured to:
determine a first metric of model performance of the machine learning model based on the dataset that includes the original value of each feature of the first group of features in each data record of the plurality of data records in the dataset replaced with the average value of the values of each feature of the first group of features in each data record of the plurality of data records in the dataset; and
wherein the at least one processor is further programmed or configured to:
determine a second metric of model performance of the machine learning model based on the dataset that includes an original value of each feature of a second group of features in each data record of the plurality of data records in the dataset replaced with an average value of values of each feature of a second group of features in each data record of the plurality of data records in the dataset; and
wherein the first group of features includes a group of features that is different than a group of features included in the second group of features.

14. The system of claim 10, wherein the at least one processor is further programmed or configured to:
determine whether the first metric of model performance of the machine learning model based on the average value of the values of each feature of the first group of features satisfies a threshold value of a metric of model performance of the machine learning model; and
determine whether the second metric of model performance of the machine learning model based on the average value of the values of each feature of the second group of features satisfies the threshold value of a metric of model performance of the machine learning model.

15. The system of claim 10, wherein when determining the metric of model performance of the machine learning model based on the dataset that includes the original value of each feature in the subset of features in each data record replaced with the average value of the values of the subset of features in each data record, the at least one processor is programmed or configured to:
determine the metric of model performance of the machine learning model based on the dataset independent of re-training the machine learning model based on the dataset that includes the original value of each feature in the subset of features in each data record replaced with the average value of the values of the subset of features in each data record.

16. A computer program product for determining the feature importance of a feature of a machine learning model, the computer program product comprising at least one non-transitory computer-readable medium including one or more instructions that, when executed by at least one processor, cause the at least one processor to:
determine a plurality of features of a dataset associated with a machine learning model that has been trained, wherein the dataset was used to train the machine learning model;
determine a value of at least one feature of the plurality of features in each data record of a plurality of data records in the dataset;
calculate an average value of the values of the at least one feature in each data record of the plurality of data records in the dataset;
replace an original value of the at least one feature in each data record of the plurality of data records in the dataset with the average value of the values of the at least one feature in each data record of the plurality of data records in the dataset; and
determine a metric of model performance of the machine learning model based on the dataset that includes the original value of the at least one feature in each data record of the plurality of data records in the dataset replaced with the average value of the values of the at least one feature in each data record of the plurality of data records in the dataset.

17. The computer program product of claim 16, wherein the at least one feature is a group of features and wherein the one or more instructions further cause the at least one processor to:
randomly select the group of features from the plurality of features.

18. The computer program product of claim 16, wherein the one or more instructions that cause the at least one processor to determine the value of the at least one feature of the plurality of features in each data record of the plurality of data records in the dataset, cause the at least one processor to:
determine the value of each feature of the group of features of the plurality of features in each data record of the plurality of data records in the dataset; and
wherein the one or more instructions that cause the at least one processor to replace the original value of the at least one feature in each data record of the plurality of data records in the dataset with the average value of the values of the at least one feature in each data record of the plurality of data records in the dataset, cause the at least one processor to:
replace the original value of each feature of the group of features in each data record of the plurality of data records in the dataset with the average value of the values of each feature of the group of features in each data record of the plurality of data records in the dataset.

19. The computer program product of claim 16, wherein the at least one feature is a first group of features, and wherein the one or more instructions that cause the at least one processor to determine the metric of model performance of the machine learning model based on the dataset that includes the original value of the at least one feature in each data record of the plurality of data records in the dataset replaced with the average value of the values of the at least one feature in each data record of the plurality of data records in the dataset, cause the at least one processor to:
determine a first metric of model performance of the machine learning model based on the dataset that includes the original value of each feature of the first group of features in each data record of the plurality of data records in the dataset replaced with the average value of the values of each feature of the first group of features in each data record of the plurality of data records in the dataset; and
wherein the one or more instructions further cause the at least one processor to:
determine a second metric of model performance of the machine learning model based on the dataset that includes an original value of each feature of a second group of features in each data record of the plurality of data records in the dataset replaced with an average value of values of each feature of a second group of features in each data record of the plurality of data records in the dataset; and
wherein the first group of features includes a group of features that is different than a group of features included in the second group of features.

20. The computer program product of claim 16, wherein the one or more instructions further cause the at least one processor to:
determine whether the metric of model performance of the machine learning model based on the average value of the values of the subset of features satisfies a threshold value of a metric of model performance of the machine learning model; and
wherein the threshold value of the metric of model performance of the machine learning model is an evaluation result of the machine learning model using the dataset that includes the original value of each feature of the group of features in each data record of the plurality of data records in the dataset.
